(19) United States
(12) Patent Application Publication
(10) Pub. No.: US 2015/0276991 A1
(43) Pub. Date: Oct. 1, 2015

(54) ANTIREFLECTIVE ARTICLE, IMAGE DISPLAY DEVICE, AND METHOD OF MANUFACTURING ANTIREFLECTIVE ARTICLE

(71) Applicant: FUJIFILM Corporation, Tokyo (JP)

(72) Inventors: Makoto UCHIMURA, Kanagawa (JP); Shuntaro IBUKI, Kanagawa (JP); Miho ASAHI, Kanagawa (JP)

(73) Assignee: FUJIFILM Corporation, Tokyo (JP)

(21) Appl. No.: 14/670,485

(22) Filed: Mar. 27, 2015

(30) Foreign Application Priority Data
Mar. 31, 2014 (JP) 2014-074786

(51) Int. Cl. G02B 1/118; G02B 1/111; C03C 17/25; C03C 21/00; C03C 17/00; C03C 17/32

(52) U.S. Cl. CPC G02B 1/118; C03C 17/007; C03C 17/32; C03C 17/25; C03C 21/00; G02B 1/111

(57) ABSTRACT

There is provided an antireflective article including a chemically reinforced glass substrate with a surface compressive stress of 30 kg/mm² or more and an antireflection layer containing a specific binder resin, specific metal oxide particles, and a specific metal chelate catalyst, above the chemically reinforced glass substrate, wherein the antireflection layer has a moth-eye structure in an unevenness shape constituted by the metal oxide particles on a surface at a side opposite to a side at which the chemically reinforced glass substrate is provided.

### CROSS-REFERENCE TO RELATED APPLICATION(S)

The present application claims priority from Japanese Patent Application No. JP 2014-074786 filed on Mar. 31, 2014, the entire contents of which are incorporated herein by reference.

### BACKGROUND

1. Field

The present invention relates to an antireflective article, an image display device, and a method of manufacturing an antireflective article.

2. Description of Related Art

In an image display device such as a cathode ray tube display (CRT), a plasma display (PDP), an electroluminescence display (ELD), a fluorescent display (VFD), a field emission display (FED), and a liquid crystal display (LCD), an antireflection function is generally imparted in order to prevent contrast reduction or anti-glare of the image due to the reflection of external lights on the surface of the display. Further, the antireflection function may be imparted in any case other than the image display device.

As a method of imparting the antireflection function, there is a method of using an antireflective article including an antireflection layer formed on a substrate. An antireflection layer has been known, which includes, on a substrate surface, an antireflection layer having a fine unevenness shape in which a period is shorter than the wavelength of the visible light, that is, an antireflective having a so-called moth-eye structure. By the moth-eye structure, a reflective index gradient layer whose refractive index is changed continuously from the air towards a bulk material inside the substrate is artificially produced, so that reflection of light may be prevented.

As an antireflection layer having the moth-eye structure, Japanese Patent Laid-Open Publication No. 2009-139796 discloses an antireflection layer having an unevenness structure formed by applying an application liquid containing a transparent resin monomer and fin particles on a transparent substrate, curing the application liquid to form a transparent resin dispersed with the fine particles, and then, etching the transparent resin.

Further, although there is no mention about the moth-eye structure, Japanese Patent Laid-Open Publication No. H5-13021 discloses a method of manufacturing an anti-reflector in which an application liquid containing tetraethoxysilane and ultrafine particles is applied on a glass substrate and calcined so that the ultrafine particles are fixed by a thin film of SiO2 produced by decomposition of the tetraethoxysilane.

Although there is no mention about the moth-eye structure, Japanese Patent Laid-Open Publication No. 2002-234754 discloses a chemically reinforced glass on which a functional thin film is applied by a sol-gel method.

However, in the antireflection layer described in Patent Document 1, it has been found that, when high pressure is applied to the moth-eye structure formed by the particles in the thickness direction, the particles are crushed, thereby causing a problem that the antireflective function is lost.

The present inventors have studied on this problem and found that, when metal oxide particles whose hardness is improved by performing a calcination treatment are used as particles forming the moth-eye structure and a resin formed by a condensation reaction of alkoxysilane is used as a binder, durability against pressure in the thickness direction is enhanced, but, since the content of the hydroxyl group on the particle surface is reduced by the calcination treatment, a binding force with the binder resin is lowered, thereby causing another problem that separation of particles occurs.

In order to enhance the binding force of the metal oxide particles having a small hydroxyl group content and the binder resin, a method of subjecting a reaction at a high temperature or a method of using a catalyst to enhance the reactivity may be considered.

Meanwhile, as a substrate for a display surface of a smart phone or a tablet PC, a chemically reinforced glass is generally used from the viewpoint of strength and thickness.

In a case where the chemically reinforced glass is used as a substrate, when an antireflection layer having a moth-eye structure is formed on the substrate and subjected to reaction at a high temperature of 200° C. or higher in order to enhance the binding force of the metal oxide particles having a small hydroxyl group content and the binder resin, the strength of the chemically reinforced glass is lowered. Further, when a highly reactive catalyst such as acid is used, alkoxysilane, which is a material of the binder resin, is gelled, so that the transparency of the antireflection layer is lowered.

As described above, an object of the present invention is to provide an antireflective article including, on a chemically reinforced glass substrate, an antireflection layer having a moth-eye structure on its surface, which has high hardness, high durability against pressure in a thickness direction of the moth-eye structure, no separation of particles, low reflectivity, and high transparency. Further, another object of the present invention is to provide an image display device including the antireflective article, and a method of manufacturing the antireflective article.

The present inventors have intensively studied and found that the above-mentioned problem is solved by using metal oxide particles having a low surface hydroxyl group content and high hardness as the particles forming the moth-eye structure of the antireflection layer on the chemically reinforced glass substrate, using a resin formed by condensation reaction of alkoxysilane as the binder resin of the antireflection layer, and using a metal chelate catalyst.

### SUMMARY

According to an exemplary embodiment of the present invention, the followings may be provided.

(1) An antireflective article including: a chemically reinforced glass substrate with a surface compressive stress of 30 kg/mm² or more; and an antireflection layer containing a binder resin, metal oxide particles, and a metal chelate catalyst, above the chemically reinforced glass substrate, wherein the antireflection layer has a moth-eye structure in an unevenness shape constituted by the metal oxide particles on a surface at a side opposite to a side at which the chemically reinforced glass substrate is provided, the unevenness shape of the antireflection layer has a ratio B/A of 0.5 or more, which is a ratio of a distance B between a center of apexes of adjacent convex portions and a concave portion to a distance A between the apexes of the adjacent convex portions, an average primary particle diameter of the metal oxide particles is 150 nm to 380 nm, a surface hydroxyl group content of the metal oxide particles is 1.00×10⁻¹ or less, an indentation hardness of the metal oxide particles is 400 MPa or more, and the binder resin is a resin formed by a hydrolysis and a condensation reaction of a compound represented by Formula (1):

Rₙ—Si—X₄₋ₙ Formula (1)

wherein R represents an alkyl group having 1 to 10 carbon atoms, which may be substituted with other elements than a carbon atom, X represents a hydrolysable group, n represents 0 to 2, R's may be same or different, and X's may be same or different.

(2) The antireflective article according to (1), wherein the metal oxide particles are silica particles.

(3) The antireflective article according to (1) or (2), wherein the metal oxide particles are calcined silica particles.

(4) The antireflective articles according to any one of (1) to (3), wherein R in Formula (1) is a methyl group or an ethyl group.

(5) The antireflective articles according to any one of (1) to (4), wherein n in Formula (1) represents 4.

(6) The antireflective article according to any one of (1) to (5), wherein the metal chelate catalyst is a metal complex constituted by a metal element selected from Group 2, Group 4, Group 5, and Group 13 of a periodic table, and an oxo or hydroxyl oxygen-containing compound selected from β-dikentone, ketoester, hydroxycarboxylic acid or ester thereof, aminoalcohol, and an enolic active hydrogen compound.

(7) The antireflective article according to any one of (1) to (6), wherein a hardcoat layer is provided between the chemically reinforced glass substrate and the antireflection layer.

(8) A cover glass comprising the antireflective article according to any one of (1) to (7).

(9) An image display device including the antireflective article according to any one of (1) to (7), or the cover glass according to (8).

(10) A method of manufacturing an antireflection article including a chemically reinforced glass substrate with a surface compressive stress of 30 kg/mm² or more and an antireflection layer containing a binder resin, metal oxide particles, and a metal chelate catalyst above the chemically reinforced glass substrate, the method comprising:

applying, above the chemically reinforced glass substrate, a composition containing:
the metal oxide particles having an average primary particle diameter of 150 nm to 380 nm, a surface hydroxyl group content of 1.00×10⁻¹ or less, and an indentation hardness of 400 MPa or more;
the metal chelate catalyst; and
a compound represented by Formula (1):

Rₙ—Si—X₄₋ₙ Formula (1)
wherein R represents an alkyl group having 1 to 10 carbon atoms, which may be substituted with other elements than a carbon atom,
X represents a hydrolysable group,
n represents 0 to 2, and
R's may be same or different, and X's may be same or different; and

subjecting the compound represented by Formula (1) to a hydrolysis and a condensation reaction to form the binder,

wherein the antireflection layer has a moth-eye structure in an unevenness shape constituted by the metal oxide particles on a surface at a side opposite to a side at which the chemically reinforced glass substrate is provided, and

the unevenness shape of the antireflection layer has a ratio B/A of 0.5 or more, which is a ratio of a distance B between a center of apexes of adjacent convex portions and a concave portion to a distance A between the apexes of the adjacent convex portions.

According to the present invention, it is possible to provide an antireflective article including, on a chemically reinforced glass substrate, an antireflection layer having a moth-eye structure on its surface, which has high hardness, high durability against pressure in a thickness direction of the moth-eye structure, no separation of particles, low reflectivity, and high transparency. Further, it is possible to provide an image display device including the antireflective article, and a method of manufacturing the antireflective article.

### BRIEF DESCRIPTION OF DRAWINGS

FIG. 1 is a schematic view illustrating an exemplary antireflective article of the present invention.

FIG. 2 is a cross-sectional SEM photograph illustrating an exemplary antireflective article of the present invention.

### DETAILED DESCRIPTION OF EXEMPLARY EMBODIMENT

[Antireflective Article]

An antireflective article of an exemplary embodiment of the present invention including: a chemically reinforced glass substrate with a surface compressive stress of 30 kg/mm² or more; and an antireflection layer containing a binder resin, metal oxide particles, and a metal chelate catalyst, above the chemically reinforced glass substrate, wherein the antireflection layer has a moth-eye structure in an unevenness shape constituted by the metal oxide particles on a surface at a side opposite to a side at which the chemically reinforced glass substrate is provided, the unevenness shape of the antireflection layer has a ratio B/A of 0.5 or more, which is a ratio of a distance B between a center of apexes of adjacent convex portions and a concave portion to a distance A between the apexes of the adjacent convex portions, an average primary particle diameter of the metal oxide particles is 150 nm to 380 mn, a surface hydroxyl group content of the metal oxide particles is 1.00×10⁻¹ or less, an indentation hardness of the metal oxide particles is 400 MPa or more, and the binder resin is a resin formed by a hydrolysis and a condensation reaction of a compound represented by Formula (1):

Rₙ—Si—X₄₋ₙ Formula (1)

wherein R represents an alkyl group having 1 to 10 carbon atoms, which may be substituted with other elements than a carbon atom, X represents a hydrolysable group, n represents 0 to 2, R's may be same or different, and X's may be same or different.

Hereinafter, the present invention will be described in detail.

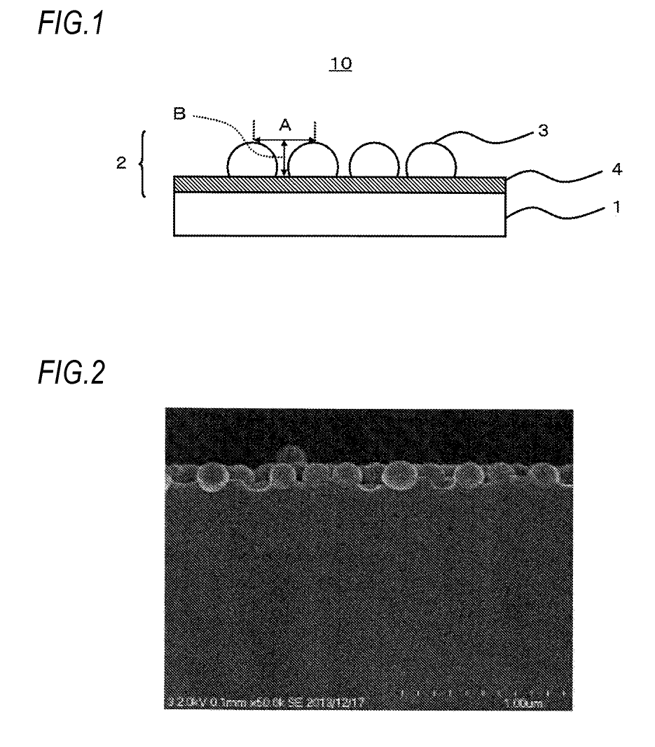

FIG. 1 illustrates a preferred exemplary embodiment of the antireflective article of the present invention.

The antireflective article 1 of FIG. 1 includes a chemically reinforced substrate 1 and an antireflection layer 2. The antireflection layer 2 has a moth-eye structure in an unevenness shape formed by metal oxide particles 3 on a surface at a side opposite to a side at which the chemically reinforced glass substrate 1 is provided.

The antireflection layer 2 includes the metal oxide particles 3 and a binder resin 4.

(Moth-Eye Structure)

The surface of the antireflection layer opposite to the chemically reinforced glass substrate has a moth-eye structure in an unevenness shape formed by the metal oxide particles.

Here, the moth-eye structure is a processed surface of substance (material) for suppressing reflection of light, and refers to a structure having a periodic microstructured pattern. Particularly, for the purpose of suppressing reflection of visible light, the moth-eye structure refers to a structure having a microstructured pattern with a period less than 780 nm. When the period of the microstructured pattern is less than 380 nm, it is preferred in that the color of the reflected light disappears. Further, when the period is 100 nm or more, the microstructured pattern may be recognized by light with a wavelength of 380 nm. Therefore, it is preferred in that the antireflection is excellent. The presence of the moth-eye structure may be confirmed by observing the surface shape with a scanning electron microscope (SEM) or an atomic force microscope (AFM) and examining whether the microstructured pattern is formed.

The unevenness shape of the antireflection layer of the antireflective article of the present invention has a ratio B/A greater than 0.5, which is a ratio of a distance A between apexes of adjacent convex portions and a distance B between a center of the apexes of the adjacent convex portions and a concave portion. If B/A is greater than 0.5, the depth of the concave portion is increased with respect to the distance between the convex portions, so that a reflective index gradient layer whose refractive index is changed more moderately from the air to the inside of the antireflection layer is produced. Therefore, the reflectivity may be reduced.

A method of measuring the ratio B/A, which is a ratio of the distance A between the apexes of the adjacent convex portions and the distance B between the center of the apexes of the adjacent convex portions and the concave portion, will be described below in more detail.

The ratio B/A may be measured by cross-sectional SEM observation of the antireflection layer. After an antireflective article sample is gashed by, for example, a diamond cutter, SEM observation is performed at an appropriate magnification (about 5,000 times) by cutting through the gash to expose its cross-section. For ease of observation, an appropriate processing such as carbon deposition or etching may be performed on the sample. Assuming that a distance between apexes of adjacent convex portions is “A” at an interface formed by the air and the sample, and a distance between a straight line connecting the adjacent convex portions and a concave portion which is a point where its perpendicular bisector reaches a particle or the binder resin is “B” in a plane perpendicular to the substrate surface including the apexes of the adjacent convex portions, the ratio B/A is calculated as an average value of B/A when measuring the length at 100 points.

In the SEM photograph, the distance A between the apexes of the adjacent convex portions and the distance B between the center of the apexes of the adjacent convex portions and the concave portion may not be precisely measured with respect to all the photographed unevenness. In such a case, the length may be measured by paying attention to the convex portions and the concave portion photographed in front in the SEM image (see FIG. 2).

Meanwhile, as for the concave portion, it is necessary to measure the length at the same depth as the particles forming two adjacent convex portions to be measured in the SEM image. If the length was measured by regarding a distance up to particles photographed at a more front side as “B”, “B” would be estimated small.

The ratio B/A is preferably 0.5 or more, more preferably 0.6 or more, and particularly preferably 0.7 or more. In addition, the ratio is preferably 0.9 or less from the viewpoint that the moth-eye structure is firmly fixed and the scratch resistance is excellent.

It is desirable to compactly lay the metal oxide particles at a uniform and high filling ratio in order to reduce the reflectivity. It is also important that the filling ratio is not too high. If the filling ratio is too high, the adjacent particles come in contact with each other, so that the ratio B/A of the unevenness is reduced, resulting in higher reflectivity.

From the above-mentioned viewpoint, the content of the metal oxide particles is preferably adjusted to be uniform throughout the antireflection layer. The filling ratio may be measured as an area occupancy ratio of particles located closest to the surface side when observing the metal oxide particles from the surface, by SEM. The filling ratio is preferably 30% to 95%, more preferably 40% to 90%, and particularly preferably 50% to 85%.

(Metal Oxide Particles)

The metal oxide particles forming the moth-eye structure of the antireflection layer will be described.

The metal oxide particles has an average primary particle diameter of 150 nm to 380 nm, a surface hydroxyl group content of 1.00×10⁻¹ or less, and an indentation hardness of 400 MPa or more.

The average primary particle diameter of the metal oxide particles is 150 nm to 380 nm, preferably 150 nm to 320 nm, and more preferably 150 nm to 250 nm. When the average primary particle diameter is 150 nm or more, it is preferred in that aggregation of the particles is suppressed. When the average primary particle diameter is 380 nm or less, it is preferred in that haze is suppressed.

The average primary particle diameter refers to a 50% accumulative particle diameter of a volume average particle diameter. When the average primary particle diameter of the metal oxide particles included in the antireflection layer is measured, the measurement may be performed by an electron microscope. For example, a sectioned TEM image of the antireflective image is photographed to measure diameters of 100 primary particles, and the volume is calculated to obtain a 50% accumulative particle diameter as the average primary particle diameter. When a particle does not have a spherical diameter, an average of the major diameter and the minor diameter thereof is considered as a diameter of the primary particle.

In the present invention, the hydroxyl group content of the particle surface is defined as follows. The hydroxyl group content is measured by a solid-state ²⁹Si NMR (²⁹Si CP/MAS). When a signal intensity of a metal element M on a surface of a metal oxide particle, which is bound to n hydroxyl groups, is assumed as “Qn”, the hydroxyl group content of the particle surface is a sum of the existent Qn×n÷(the square of a particle radius (unit: nm)). For example, when the particles are silica (particle radius R), silicon bound to four neutral oxygen atoms (signal intensity Q4), silicon bound to three neutral oxygen atoms and one hydroxyl group (signal intensity Q3), and silicon bound to two neutral oxygen atoms and two hydroxyl groups (signal intensity Q2) are present, and the hydroxyl group content of the particle surface is (Q3×1+Q2×2)/R². In the case of silica, the chemical shift is −91 ppm to −94 ppm for Q2, and −100 ppm to −102 ppm for Q3.

As the surface is hardened by calcination, the hydroxyl group content of the particle surface is decreased and preferably 1.00×10⁻⁵ to 1.00×10⁻¹, more preferably 1.00×10⁻⁴ to 5.00×10⁻², and particularly preferably 5.00×10⁻⁴ to 1.00×10⁻³.

The indentation hardness of the metal oxide particles is 400 MPa or more, preferably 500 MPa or more, and more preferably 600 MPa. When the indentation hardness of the metal oxide particles is 400 MPa or more, it is preferred in that the durability against pressure in the thickness direction of the moth-eye structure is enhanced. Further, since the metal oxide particles are brittle and fragile, the hardness of the metal oxide particles is preferably 1,000 MPa.

The indentation hardness of the metal oxide particles may be measured by a nanoindenter. The indentation hardness may be measured by preparing, as a sample, fine particles which are fixed so as not to move when measured with a resin in a state where their heads are out by being arranged on a substrate (e.g., a glass plate or a quartz plate), which is harder than themselves, so as not to overlap in more than one tier, and pressing it with a diamond indenter. The indentation position may be specified by a triboindenter.

Examples of the metal oxide particles may include silica particles, titania particles, zirconia particles, and antimony pentaoxide particles, and preferably silica particles from the viewpoint that haze is hardly generated and the moth-eye structure is easily formed due to the refractive index close to that of the binder resin formed of the compound represented by Formula (1).

The metal oxide particles are particularly preferably calcined silica particles for the reason that the particles have appropriate surface hydroxyl group content and high indentation hardness.

The calcined silica particles may be prepared by a known technique in which a hydrolysable silicon compound are subjected to hydrolysis and condensation in an organic solvent containing water and a catalyst to obtain silica particles, and the silica particles are calcined, and reference may be made to, for example, Japanese Patent Laid-Open Publication No. 2003-176121, Japanese Patent Laid-Open Publication No. 2008-137854, and Japanese Patent Laid-Open Publication No. 2012-136363.

The silicon compound as a material for preparing the calcined silica particles is not particularly limited, but examples thereof may include a chlorosilane compound such as tetrachlorosilane, methyltrichlorosilane, phenyltrichlorosilane, dimethyldichlorosilane, diphenyldichlorosilane, methylvinyldichlorosilane, trimethylchlorosilane, and methyldiphenylchlorosilane; an alkoxysilane compound such as tetramethoxysilane, tetraethoxysilane, tetraisopropoxysilane, tetrabutoxysilane, methyltrimethoxysilane, methyltriethoxysilane, trimethoxyvinylsilane, triethoxyvinylsilane, 3-glycidoxypropyltrimethoxysilane, 3-chloropropyltrimethoxysilane, 3-mercaptopropyltrimethoxysilane, 3-(2-aminoethylamino)propyltrimethoxysilane, phenyltrimethoxysilane, phenyltriethoxysilane, dimethyldimethoxysilane, dimethyldiethoxysilane, 3-glycidoxypropylmethyldimethoxysilane, 3-glycidoxypropylmethyldiethoxysilane, 3-chloropropylmethyldimethoxysilane, diphenyldimethoxysilane, diphenyldiethoxysilane, dimethoxydiethoxysilane, trimethylmethoxysilane, and trimethylethoxysilane; an acyloxysilane compound such as tetraacetoxysilane, methyltriacetoxysilane, phenyltriacetoxysilane, dimethyldiacetoxysilane, diphenyldiacetoxysilane, and trimethylacetoxysilane; and a silanol compound such as dimethylsilanediol, diphenylsilanediol, trimethylsilanol. Among the silane compounds as exemplified above, the alkoxysilane compound is particularly preferred in that it is more easily available and no halogen atom is contained as an impurity in the resultant calcined silica particles. As a preferred form of the calcined silica particles according to the present invention, it is preferred that the content of halogen atoms is substantially 0%, that is, no halogen atom is detected.

The calcination temperature is not particularly limited, but preferably 800° C. to 1,300° C., and more preferably 1,000° C. to 1,200° C.

The shape of the metal oxide particles are most preferably spherical, but may be amorphous other than spherical.

The metal oxide particles may be prepared by calcining commercially available particles. Specific examples thereof may include Snowtex MP-2040 (average primary particle diameter: 200 nm, silica manufactured by NISSAN CHEMICAL INDUSTRIES, LTD.), SEAHOSTAR KE-P10 (average primary particle diameter: 150 nm, amorphous silica manufactured by Nippon Shokubai Co., Ltd.), SEAHOSTAR KE-P20 (average primary particle diameter: 200 nm, amorphous silica manufactured by Nippon Shokubai Co., Ltd.), SEAHOSTAR KE-S30 (average primary particle diameter: 300 nm, amorphous silica manufactured by Nippon Shokubai Co., Ltd.), and ASFP-20 (average primary particle diameter: 200 nm, alumina manufactured by Denki Kagaku Kogyo K.K.). Further, as long as the requirements of the present invention are satisfied, commercially available particles may be used as they are.

The content ratio of the metal oxide particles and the binder resin (mass of the metal oxide particles/mass of the binder resin) is preferably 20/80 to 60/40, more preferably 30/70 to 50/50, and particularly preferably 35/65 to 40/60.

When (mass of the metal oxide particles/mass of the binder resin) is 20/80 or more, it is preferred in that the reflectivity is reduced as the ratio B/A of the unevenness of the moth-eye structure is increased. When (mass of the metal oxide particles/mass of the binder resin) is 60/40 or less, it is preferred in that any failure or deterioration of haze is not caused because adhesion of the metal oxide particles and the substrate is enhanced or the metal oxide particles are easily aggregated during the manufacturing process.

(Binder Resin)

The binder resin of the antireflection layer will be described.

The binder resin of the antireflection layer is a resin formed by condensation reaction of a compound obtained from the hydrolysis of the compound represented by Formula (1).

Rₙ—Si—X₄₋ₙ Formula (1)

In Formula (1), R represents an alkyl group having 1 to 10 carbon atoms, which may be substituted with other elements other than carbon. X represents a hydrolysable group. n represents 0 to 2. R's may be same or different, and X's may be same or different.

Examples of the hydrolysable group may include an alkoxy group, a halogen atom, and an amino group, and specific examples of Formula (1) may include tetraethoxysilane, tetrapropoxysilane, tetrabutoxysilane, methyltrimethoxysilane, methyltriethoxysilane, dimethyldiethoxysilane, phenyltriethoxysilane, n-propyltrimethoxysilane, n-propyltriethoxysilane, hexyl trim ethoxysilane, hexyltriethoxysilane, methyltrichlorosilane, dimethyldichlorosilane, phenyltrichlorosilane, vinyltrimethoxysilane, vinyltriethoxysilane, 3-glycidoxypropyltrimethoxysilane, 3-methacryloxypropylmethyldimethoxysilane, 3-methacryloxypropyltrimethoxysilane, 3-methacryloxypropyltriethoxysilane, 3-aminopropyltrimethoxysilane, 3-aminopropyltriethoxysilane, 3-mercaptopropylmethyldimethoxysilane, and 3-mercaptopropyltrimethoxysilane.

Further, one in which the compound of Formula (1) is subjected to condensation reaction multiple times in advance may be used, and examples thereof may include Ethyl Silicate 40 (manufactured by COLCOAT CO., Ltd.), Ethyl Silicate 48 (manufactured by COLCOAT CO., Ltd.), Methyl Silicate 51 (manufactured by COLCOAT CO., Ltd.), and Methyl Silicate 53A (manufactured by COLCOAT CO., Ltd.).

The compound represented by Formula (1) is a compound for binder resin formation.

In Formula (1), R represents an alkyl group having 1 to 10 carbon atoms, and may have any substituent. Examples of the substituent may include a halogen atom such as chlorine, and a functional group such as a mercapto group, an amino group, a (meth)acryloyl group, and oxirane ring-containing group.

Further, the alkyl group of R1 represents an alkyl group having 1 to 5 carbon atoms, and preferably 1 to 3 carbon atoms from the viewpoint of the reactivity. Each of R's may be the same as or different from every other R's.

In Formula (1), n represents 0 to 2, preferably 0 or 1, and more preferably 0. The compound represented by Formula (1) may be subjected to condensation reaction by adding a catalyst for hydrolysis and water thereto, mixing them, applying the mixture on a substrate, subjecting to hydrolysis at 60° C. to 90° C. for 1 to 10 hours, and then, heating at a temperature of 100° C. or higher for 30 minutes or more. Since the hydrolysis is facilitated with stirring in advance for 1 to 24 hours in an application liquid state, it is more suitable to make it easier for the condensation reaction to proceed.

(Metal Chelate Catalyst)

The antireflection layer includes a metal chelate catalyst.

The metal chelate catalyst is added to a composition for antireflection layer formation containing the metal oxide particles and the compound represented by Formula (1), and preferably acts as a catalyst for the condensation reaction of the compound represented by Formula (1). Further, the metal chelate catalyst also has a function to enhance the binding force of the metal oxide particles and the binder resin formed by the condensation reaction of the compound represented by Formula (1).

The metal chelate catalyst is preferably a metal complex composed of a metal element selected from Group 2, Group 4, Group 5, and Group 13 of the periodic table, and an oxo or hydroxyl oxygen-containing compound selected from β-dikentone, ketoester, hydroxycarboxylic acid or ester thereof, aminoalcohol, and an enolic active hydrogen compound.

Among the constituent metal elements, Group 2 elements such as Mg, Ca, Sr, and Ba, Group 4 elements such as Ti and Zr, Group 5 elements such as V, Nb, and Ta, and Group 13 elements such as Al and Ga are preferred, each of which forms a complex having an excellent catalytic effect. Among those, a metal complex obtained from Zr, Al, or Ti is preferred.

Examples of the oxo or hydroxyl oxygen-containing compound constituting a ligand of the metal complex may include β-dikentones such as acetylacetone (2,4-pentanedione) and 2,4-heptanedione, ketoesters such as methyl acetoacetate, ethyl acetoacetate, and butyl acetoacetate, hydroxycarboxylic acids such as lactic acid, methyl lactate, salicylic acid, ethyl salicylate, phenyl salicylate, malic acid, tartaric acid, and methyl tartrate, and ester thereof, ketoalcohols such as 4-hydroxy-4-methyl-2-pentanone, 4-hydroxy-2-pentanone, 4-hydroxy-4-methyl-2-heptanone, and 4-hydroxy-2-heptanone, aminoalcohols such as monoethanolamine, N,N-dimethylethanolamine, N-methyl-monoethanolamine, diethanolamine, and triethanolamine, an enolic active compound such as methylolmelamine, methylolurea, mcthylolacrylamide, and diethyl malonate ester, and a compound having a substituent on a methyl group, a methylene group or a carbonyl carbon of acetylacetone (2,4-pentandione).

A preferred ligand is an acetylacetone derivative, which refers to a compound having a substituent on a methyl group, a methylene group or a carbonyl carbon of acetylacetone. The substituent substituted on the methyl group of acetylacetone is a straight or branched alkyl group having 1 to 3 carbon atoms, an acyl group, a hydroxyalkyl group, a carboxyalkyl group, an alkoxy group, or an alkoxyalkyl group, the substituent substituted on the methylene group of acetylacetone is a carboxy group, a straight or branched carboxyalkyl group or hydroxyalkyl group having 1 to 3 carbon atoms, and the substituent substituted on the carbonyl carbon of acetylacetone is an alkyl group having 1 to 3 carbon atoms, while a hydrogen atom is added to the carbonyl oxygen which then turns to a hydroxyl group in this case.

Specific examples of a preferred acetylacetone derivative may include ethylcarbonylacetone, n-propylcarbonylacetone, i-propylcarbonyl acetone, diacetylacetone, 1-acetyl-1-propionyl-acetylacetone, hydroxyethylcarbonylace tone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol. Among those, acetylacetone and diacetylacetone are particularly preferred. The complex of the acetylacetone derivative and the metal element is a mononuclear complex with 1 to 4 acetylacetone derivative coordinated per metal element, and in a case where the coordination number of the metal element is larger than the number of coodinatable bonding hands of the acetylacetone derivative, a ligand generally used in an ordinary complex, such as a water molecule, a halogen ion, a nitro group, and an ammonio group, may also be coordinated thereto.

Examples of a preferred metal complex may include tris(acetylacetonato)aluminum complex salt, di(acetylacetonato)aluminum.aquocomplex salt, mono(acetylacetonato)aluminum.chlorocomplex salt, di(diacetylacetonato)aluminum complex salt, ethylacetoacetate aluminum diisopropylate, aluminum tris(ethylacetoacetate), cyclic aluminum oxide isopropylate, tris(acetylacetonato)barium complex salt, di(acetylacetonato)titanium complex salt, tris(acetylacetonato)titanium complex salt, di-i-propoxy.bis(acetylacetonato)titanium complex salt, zirconium tris(ethylacetoacetate), and zirconium tris(benzoate) complex salt. They are excellent in stability in an aqueous application liquid and an effect for facilitating gelation in a sol-gel reaction upon heating and drying, but, among those, ethylacetoacetate aluminum diisopropylate, aluminum tris(ethylacetoacetate), di(acetylacetonato)titanium complex salt, and zirconium tris(ethylacetoacetate) are preferred.

The descriptions of a counter salt of the metal complex are omitted in the present specification, but the kind of the counter salt is arbitrary as long as it is a water-soluble salt which maintains the charge neutrality of the complex compound, and a salt form in which stoichiometric neutrality is ensured, such as, for example, nitrate, halogenate, sulfate, and phosphates, is used.

A behavior of the metal complex in a silica sol-gel reaction is described in detail in J. Sol-Gel. Sci. and Tec. 16. 209 (1999).

The metal complex catalyst is readily available as a commercial product, and also is obtained by a known synthesis, for example, a reaction of each metal chloride and alcohol.

The content of the metal chelate catalyst in the antireflection layer is preferably 0.1% by mass to 10% by mass, more preferably 0.5% by mass to 5% by mass, and particularly preferably 1% by mass to 3% by mass based on the binder resin. If the content is less than 0.1% by mass, the hardness is the film is insufficient, and if the content is larger than 10% by mass, condensation with the binder resin proceeds excessively. Therefore, the binding of particles with the binder is insufficient, so that the particles are easily separated.

(Chemically Reinforced Glass Substrate)

The chemically reinforced glass substrate of the antireflective article of the present invention is a chemically reinforced glass substrate having a compressive stress of 30 kg/mm² or more on its surface. The compressive stress on the surface of the chemically reinforced glass substrate is preferably 40 kg/mm² or more, and more preferably 50 kg/mm² or more. Further, the compressive stress is preferably 200 kg/mm² or less from the viewpoint that processing after manufacturing the antireflective article becomes difficult.

The thickness of the chemically reinforced glass substrate is preferably 0.4 mm to 3 nm, more preferably 0.5 mm to 2 mm, and particularly preferably 0.6 mm to 1 mm.

The chemically reinforced glass substrate is commercially available. Examples thereof may include a chemically reinforced glass substrate manufactured by Matsunami Glass Ind., Ltd., ‘Gorilla Glass’ manufactured by Corning, ‘Dragontrail Glass’ manufactured by ASAHI GLASS Co., Ltd., ‘CX-01’ manufactured by Nippon Electric Glass Co., Ltd., ‘ARMOREX’ manufactured by Central Glass Co., Ltd., a chemically reinforced glass substrate manufactured by Nippon Sheet Glass Company, Ltd., and Xensation Cover′ manufactured by SCHOTT NIPPON K.K.

(Other Functional Layers)

The antireflective article of the present invention may have other functional layers in addition to the antireflection layer.

For example, an embodiment having a hardcoat layer between the chemically reinforced glass substrate and the antireflection layer may be preferred. Further, an easy-to-adhere layer for imparting adhesion and a layer for imparting an antistatic property may be provided, and a plurality of them may be provided.

[Manufacturing Method of Antireflective Article]

A manufacturing method of the antireflective article of the present invention is not particularly limited, but a manufacturing method using an application method is preferred from the viewpoint of production efficiency.

That is, a method of manufacturing an antireflection article including a chemically reinforced glass substrate with a surface compressive stress of 30 kg/mm² or more and an antireflection layer containing a binder resin, metal oxide particles, and a metal chelate catalyst above the chemically reinforced glass substrate, includes:

applying, above the chemically reinforced glass substrate, a composition containing:
the metal oxide particles having an average primary particle diameter of 150 nm to 380 nm, a surface hydroxyl group content of 1.00×10⁻¹ or less, and an indentation hardness of 400 MPa or more;
the metal chelate catalyst; and
a compound represented by Formula (1):

Rₙ—Si—X₄₋ₙ Formula (1)
wherein R represents an alkyl group having 1 to 10 carbon atoms, which may be substituted with other elements than a carbon atom,
X represents a hydrolysable group,
n represents 0 to 2, and
R's may be same or different, and X's may be same or different; and

subjecting the compound represented by Formula (1) to a hydrolysis and a condensation reaction to form the binder,

wherein the antireflection layer has a moth-eye structure in an unevenness shape constituted by the metal oxide particles on a surface at a side opposite to a side at which the chemically reinforced glass substrate is provided, and

the unevenness shape of the antireflection layer has a ratio B/A of 0.5 or more, which is a ratio of a distance B between a center of apexes of adjacent convex portions and a concave portion to a distance A between the apexes of the adjacent convex portions.

The compound represented by Formula (1), the metal chelate catalyst, and the metal oxide particles contained in the composition for antireflection layer formation are the same as those as described above.

The composition for antireflection layer formation may contain a solvent, a dispersant of the particles, leveling agent, and an antifouling agent.

As for the solvent, one having a polarity closer to that of the fine particles is preferably selected from the viewpoint of enhancing the dispersibility. Specifically, for example, in a case where the fine particles are metal oxide fine particles, an alcohol-based solvent is preferred, and examples thereof may include methanol, ethanol, 2-propanol, 1-propanol, and butanol. Further, for example, in a case where the fine particles are hydrophobically surface-modified metal resin particles or resin particles, a ketone-based, ester-based, carbonate-based, alkane, or aromatic group-based solvent is preferred, and examples thereof may include methyl ethyl ketone (MEK), dimethyl carbonate, methyl acetate, acetone, methylene chloride, and cyclohexanone. These solvents may be used in mixture of two or more as long as the dispersibility is not significantly deteriorated.

The dispersant of the particles may make it easy for particles to be uniformly arranged by lowering the cohesive force between the particles. The dispersant is not particularly limited, but is preferably an anionic compound such as sulfate and phosphate, a cationic compound such as an aliphatic amine salt and a quaternary ammonium salt, a nonionic compound, or a polymer compound, and more preferably a polymer compound because of high degree of freedom of selection for each of adsorptive groups and sterically repulsive groups. The dispersant may be commercially available. Examples thereof may include DISPERBYK 160, DISPERBYK 161, DISPERBYK 161 DISPERBYK 163, DISPERBYK 164, DISPERBYK 166, DISPERBYK 167, DISPERBYK 171, DISPERBYK 180, DISPERBYK 182, DISPERBYK 2000, DISPERBYK 2001, DISPERBYK 2164, Bykumen, BYK-P104, BYK-P104S, BYK-220S, Anti-Terra203, Anti-Terra204, and Anti-Terra205 (all trade names), manufactured by BYK-Chemie Japan K. K.

The leveling agent may make it easy for particles or the binder resin to be uniformly arranged by lowering the surface tension of the application liquid to stabilize the liquid after application. Examples thereof may include compounds described in Japanese Patent Laid-Open Publication No. 2004-331812 and Japanese Patent Laid-Open Publication No. 2004-163610.

The antifouling agent may suppress adhesion of strains or fingerprints by imparting water and oil repellency to the moth-eye structure. Examples thereof may include compounds described in Japanese Patent Laid-Open Publication No. 2012-88699.

The application method of the composition for antireflection layer formation is not particularly limited, but any known method may be used. Examples thereof may include a dip coating method, an air knife coating method, a curtain coating method, a roller coating method, a wire bar coating method, a gravure coating method, and a die coating method.

From the viewpoint that it is easy to be uniformly applied, the solid concentration of the composition for antireflection layer formation is preferably 5% by mass to 60% by mass, and more preferably 10% by mass to 50% by mass.

[Cover Glass]

The antireflective article of the present invention may be used as a cover glass because it has an antireflection function and high hardness. The cover glass including the antireflective article of the present invention may be disposed on, for example, a display surface of an image display device and hence suitably used in a smart phone or a tablet PC.

[Image Display Device]

An image display device of the present invention includes the antireflective article of the present invention.

The antireflective article of the present invention may be suitably used in an image display device such as a liquid crystal display (LCD), a plasma display (PDP), an electroluminescence display (ELD), or a cathode ray tube display (CRT), and a liquid crystal display is particularly preferred. The antireflective article may be used as a cover glass of such an image display device.

### EXAMPLES

The present invention will be described in more detail with reference to the following examples. Materials, reagents, amounts and ratios of substances, and operations described in the following examples may be appropriately changed without departing from the spirit of the present invention. Accordingly, the spirit of the present invention is not limited to the following examples.

(Preparation of Application Liquid for Antireflection Layer Formation)

To have composition shown in Table 1 below, each component was introduced into a mixing tank, stirred for 60 minutes, dispersed by an ultrasonic disperser for 30 minutes, and filtered with a polypropylene filter having a pore size of 5 μm to prepare application liquids for antireflection layer formation A-1 to A-18.

In Table 1 below, the value of each component represents content (% by mass) in the composition for antireflection layer formation. Further, the unit of the concentration of the application liquid is ‘% by mass’. For metal oxide particles, a hydroxyl group equivalent amount, indentation hardness, and average primary particle diameter were described.

TABLE 1

| | | Concen- | | | | | | | | | |
|---|---|---|---|---|---|---|---|---|---|---|---|
| | | tration | A-1 | A-2 | A-3 | A-4 | A-5 | A-6 | A-7 | A-8 | A-9 |
| Resin | Ethyl silicate 28 | 100% | 13.1 | 13.1 | 13.1 | 13.1 | 13.1 | 13.1 | 13.1 | 13.1 | 13.1 |
| | N-propyl silicate | 100% | | | | | | | | | |
| | Ethyl silicate 40 | 100% | | | | | | | | | |
| Fine | Silica particles a-1 | 100% | | | | | | | | 5.5 | |
| particles | (hydroxyl group | | | | | | | | | | |
| | content 2.85 × 10⁻¹, | | | | | | | | | | |
| | 330 MPa, 0.20 μm) | | | | | | | | | | |
| | Calcined silica | 100% | 5.5 | 5.5 | 5.5 | 5.5 | | | | | |
| | particles b-1 | | | | | | | | | | |
| | (hydroxyl group | | | | | | | | | | |
| | content 9.60 × 10⁻², | | | | | | | | | | |
| | 400 MPa, 0.20 μm) | | | | | | | | | | |
| | Calcined silica | 100% | | | | | 5.5 | | | | |
| | particles b-2 | | | | | | | | | | |
| | (hydroxyl group | | | | | | | | | | |
| | content 7.50 × 10⁻³, | | | | | | | | | | |
| | 500 MPa, 0.20 μm) | | | | | | | | | | |
| | Calcined silica | 100% | | | | | | 5.5 | | | |
| | particles b-3 | | | | | | | | | | |
| | (hydroxyl group | | | | | | | | | | |
| | content 9.60 × 10⁻⁴, | | | | | | | | | | |
| | 600 MPa, 0.20 μm) | | | | | | | | | | |
| | Calcined silica | 100% | | | | | | | | | 5.5 |
| | particles b-4 | | | | | | | | | | |
| | (hydroxyl group | | | | | | | | | | |
| | content 9.60 × 10⁻⁴, | | | | | | | | | | |
| | 90 MPa, 0.20 μm) | | | | | | | | | | |
| | Seahostar KE-S30 | 100% | | | | | | | 5.5 | | |
| | (hydroxyl group | | | | | | | | | | |
| | content 4.40 × 10⁻³, | | | | | | | | | | |
| | 530 MPa, 0.30 μm) | | | | | | | | | | |
| Catalyst | Tris(2,4-pentane- | 100% | 0.3 | | | | 0.3 | 0.3 | 0.3 | 0.3 | 0.3 |
| | dionato)aluminum(III) | | | | | | | | | | |
| | D-25 | 100% | | 0.3 | | | | | | | |
| | Nitric acid | 100% | | | 0.3 | | | | | | |
| Others | Water | 100% | 1.6 | 1.6 | 1.6 | 1.6 | 1.6 | 1.6 | 1.6 | 1.6 | 1.6 |
| | Ethanol | 100% | 79.5 | 79.5 | 79.5 | 79.5 | 79.5 | 79.5 | 79.5 | 79.5 | 79.5 |
| | Fluorine-containing | | | | | | | | | | |
| | compound F-1 | | | | | | | | | | |
| Mixing ratio of fine particles/resin (mass ratio) | | | 30/70 | 30/70 | 30/70 | 30/70 | 30/70 | 30/70 | 30/70 | 30/70 | 30/70 |
| Mixing ratio of catalyst to resin | | | 2.0% | 2.0% | 2.0% | 0.0% | 2.0% | 2.0% | 2.0% | 2.0% | 2.0% |
| | | Concen- | | | | | | | | | |
| | | tration | A-10 | A-11 | A-12 | A-13 | A-14 | A-15 | A-16 | A-17 | A-18 |
| Resin | Ethyl silicate 28 | 100% | 13.1 | | | 10.0 | 16.1 | 24.0 | 13.1 | 13.1 | 13.1 |
| | N-propyl silicate | 100% | | 13.1 | | | | | | | |
| | Ethyl silicate 40 | 100% | | | 13.1 | | | | | | |
| Fine | Silica particles a-1 | 100% | | | | | | | | | |
| particles | (hydroxyl group | | | | | | | | | | |
| | content 2.85 × 10⁻¹, | | | | | | | | | | |
| | 330 MPa, 0.20 μm) | | | | | | | | | | |
| | Calcined silica | 100% | | | | | | | | | |
| | particles b-1 | | | | | | | | | | |
| | (hydroxyl group | | | | | | | | | | |
| | content 9.60 × 10⁻², | | | | | | | | | | |
| | 400 MPa, 0.20 μm) | | | | | | | | | | |
| | Calcined silica | 100% | | | | | | | 5.5 | 5.5 | |
| | particles b-2 | | | | | | | | | | |
| | (hydroxyl group | | | | | | | | | | |
| | content 7.50 × 10⁻³, | | | | | | | | | | |
| | 500 MPa, 0.20 μm) | | | | | | | | | | |
| | Calcined silica | 100% | 5.5 | 5.5 | 5.5 | 5.5 | 5.5 | 5.5 | | | 5.5 |
| | particles b-3 | | | | | | | | | | |
| | (hydroxyl group | | | | | | | | | | |
| | content 9.60 × 10⁻⁴, | | | | | | | | | | |
| | 600 MPa, 0.20 μm) | | | | | | | | | | |
| | Calcined silica | 100% | | | | | | | | | |
| | particles b-4 | | | | | | | | | | |
| | (hydroxyl group | | | | | | | | | | |
| | content 9.60 × 10⁻⁴, | | | | | | | | | | |
| | 90 MPa, 0.20 μm) | | | | | | | | | | |
| | Seahostar KE-S30 | 100% | | | | | | | | | |
| | (hydroxyl group | | | | | | | | | | |
| | content 4.40 × 10⁻³, | | | | | | | | | | |
| | 530 MPa, 0.30 μm) | | | | | | | | | | |
| Catalyst | Tris(2,4-pentane- | 100% | 0.3 | 0.3 | 0.3 | 0.3 | 0.3 | 0.3 | 0.6 | 0.1 | 0.3 |
| | dionato)aluminum(III) | | | | | | | | | | |
| | D-25 | 100% | | | | | | | | | |
| | Nitric acid | 100% | | | | | | | | | |
| Others | Water | 100% | 1.6 | 1.6 | 1.6 | 1.6 | 1.6 | 1.6 | 1.6 | 1.6 | 1.6 |
| | Ethanol | 100% | 79.5 | 79.5 | 79.5 | 82.6 | 76.5 | 68.6 | 79.2 | 79.7 | 78.8 |
| | Fluorine-containing | | | | | | | | | | 0.7 |
| | compound F-1 | | | | | | | | | | |

| | | | | | | | | | |
|---|---|---|---|---|---|---|---|---|---|
| Mixing ratio of fine particles/resin (mass ratio) | 30/70 | 30/70 | 30/70 | 35/65 | 25/75 | 19/81 | 30/70 | 30/70 | 30/70 |
| Mixing ratio of catalyst to resin | 2.0% | 2.0% | 2.0% | 2.0% | 2.0% | 2.0% | 4.4% | 0.8% | 2.0% |

Compounds used are shown below, respectively.

Ethyl silicate 28: tetraethoxysilane (manufactured by COLCOAT CO., Ltd.)

N-propyl silicate: tetrapropoxysilane (manufactured by COLCOAT CO., Ltd.)

Ethyl silicate 40: tetraethoxysilane pentamer (manufactured by COLCOAT CO., Ltd.)

SEAHOSTAR KE-S30: 0.3 μ silica particles (manufactured by Nippon Shokubai Co., Ltd.)

Tris(2,4-pentanedionato)aluminum(III): Al chelate complex (manufactured by Tokyo Chemical Industry Co., Ltd.)

D-25: Ti chelate complex (Shin-Etsu Chemical Co., Ltd.)

Fluorine-containing compound F-1: a compound synthesized based on Example 1 of WO2009/133770 was used.

[Synthesis of Silica Particles a-1]

Into a reactor having a capacity of 200 L with a stirrer, a dropping device, and a thermometer, 67.54 kg of methyl alcohol and 26.33 kg of 28% by mass ammonia water (water and a catalyst) were introduced, and the liquid temperature was adjusted to 33° C. with stirring. Meanwhile, a solution of 12.70 kg of tetramethoxysilane dissolved in 5.59 kg of methyl alcohol was introduced into the dropping device. The solution was added dropwise from the dropping device over 1 hour while maintaining the liquid temperature in the reactor at 33° C., and, after the dropwise addition was completed, stirring was further carried out for 1 hour while maintaining the liquid temperature to that temperature and the tetramethoxysilane was subjected to hydrolysis and condensation to obtain a dispersion containing a silica particle precursor. The dispersion was subjected to flash drying using an instantaneous vacuum evaporator (Clarks system CVX-8B type manufactured by HOSOKAWA MICRON CORPORATION) under conditions of a heating pipe temperature of 175° C. and a reduced pressure of 200 torr (27 kPa) to obtain silica particles a-1. The average particle diameter was 200 nm, and the degree of dispersion of the particle diameter (Cv value) was 3.5%.

[Preparation of Calcined Silica Particles b-1]

Into a crucible, 5 kg of silica particles a-1 was introduced, calcined using an electric furnace at 900° C. for 1 hour, cooled, and then, pulverized using a pulverizer to obtain non-classified calcined silica particles. Further, crush and classification were performed using a jet milling classifier (IDS-2 type manufactured by Nippon Pneumatic Mfg. Co., Ltd.) to obtain calcined silica particles b-1. The average diameter of the obtained silica particles was 200 nm, and the degree of dispersion of the particle diameter (Cv value) was 3.5%.

[Preparation of Calcined Silica Particles b-2]

Into a crucible, 5 kg of silica particles a-1 was introduced, calcined using an electric furnace at 1,050° C. for 1 hour, cooled, and then, pulverized using a pulverizer to obtain non-classified calcined silica particles. Further, crush and classification were performed using a jet milling classifier (IDS-2 type manufactured by Nippon Pneumatic Mfg. Co., Ltd.) to obtain calcined silica particles b-2. The average diameter of the obtained silica particles was 200 nm, and the degree of dispersion of the particle diameter (Cv value) was 3.5%.

[Preparation of Calcined Silica Particles b-3]

Into a crucible, 5 kg of silica particles a-1 was introduced, calcined using an electric furnace at 1,050° C. for 2 hours, cooled, and then, pulverized using a pulverizer to obtain non-classified calcined silica particles. Further, crush and classification were performed using a jet milling classifier (IDS-2 type manufactured by Nippon Pneumatic Mfg. Co., Ltd.) to obtain calcined silica particles b-3. The average diameter of the obtained silica particles was 200 nm, and the degree of dispersion of the particle diameter (Cv value) was 3.5%.

[Preparation of Calcined Silica Particles b-4]

Into a reactor with a stirrer, a dropping device, and a thermometer, 100 g of methanol (special grade, manufactured by Wako Pure Chemical Industries, Ltd.), 1.1 g of dodecyltrimethylammonium chloride (manufactured by Tokyo Chemical Industry Co., Ltd.), and 0.7 g of dodecane (a hydrophobic organic compound, manufactured by Wako Pure Chemical Industries, Ltd.) were introduce and stirred to prepare liquid A. Further, to a 500-mL flask, 300 g of water, 0.825 g of 25% aqueous tetramethylammonium hydroxide solution (manufactured by Wako Pure Chemical Industries, Ltd.) was introduced and stirred to prepare liquid B. Liquid B was added to liquid A thus obtained with stirring at 25° C., followed by addition of 1.1 g of tetramethoxysilane (manufactured by Tokyo Chemical Industry Co., Ltd.) (liquid C), and stirred at 25° C. for 5 hours. The resultant cloudy aqueous solution was separated by filtration with a 5C filter paper, washed with water, and then, dried by a drier (DRM420DA manufactured by ADVANTEC) at 100° C. to obtain a white powder. The obtained white powder were heated to 600° C. at a rate of 1° C./min with air flowing (at a rate of 3 L/min) using a high-speed heating electric furnace (trade name: SK-2535E, manufactured by Motoyama Co., Ltd., and calcined at 600° C. for 2 hours to remove organic components therefrom to obtain hollow silica particles.

Subsequently, calcination was carried out at 1,050° C. for 1 hours using an electric furnace, cooled, and then, pulverized using a mortar to obtain calcined silica particles b-4.

The average diameter of the obtained silica particles was 200 nm.

[Measurement of Hydroxyl Group Content of Particle Surface]

The hydroxyl group content (Q3×3+Q2×2) was calculated by measuring the signal intensities Q2, Q3 using a solid-state ²⁹Si NMR under the following conditions.

Measurement: ²⁹Si CP/MAS

Observation frequency: ²⁹Si: 59.63 MHz

Spectral width: 22675.74 Hz

Number of times added up: 2000 times

Contact time: 5 ms

90° Pulse: 4.8 μs

Measurement waiting time: 2 seconds

MAS rotation speed: 3 kHz

Chemical shift: −91 ppm to −94 ppm for Q2, −100 to −102 ppm for Q3

[Measurement of Indentation Hardness of Metal Oxide Particles]

Into 91 g of ethanol, 8 g of each of the metal oxide particles, 0.3 g of Irgacure 184 (manufactured by BASF Japan Ltd.), and 7.7 g of KAYARAD PET30 (manufactured by Nippon Kayaku Co., Ltd.) were introduced, stirred for 10 minutes, and then, dispersed by an ultrasonic disperser for 10 minutes to obtain 15% by mass of dispersion. The dispersion was applied on a glass plate in a wet applying amount of about 3 ml/m², and cured by irradiating ultraviolet rays at a dose of 600 mJ/cm² by an air-cooled metal halide lamp while purging with nitrogen so that an oxygen concentration becomes 0.1 vol % or less in the atmosphere. Thereafter, it was observed by SEM that the metal oxide particles were not stacked in more than one tier. For this sample, the indentation hardness of the metal oxide particles was measured using a triboindenter (TI-950 manufactured by Hysitron, Inc.) under measurement conditions of a diamond indenter having a diameter of 1 μm and an indentation load of 0.05 mN.

(Manufacture of Antireflective Article)

A application liquid for antireflection layer formation as listed in Table 2 below was applied on a chemically reinforced glass substrate (a chemically reinforced glass manufactured by Matsunami Glass Ind., Ltd., surface compressive stress: 65 kg/mm², thickness: 0.7 mm), using a gravure coater. After drying at 80° C. for 4 hours, drying was carried out at 150° C. for 2 hours to manufacture an antireflective article. Antireflective article samples Al to Al 8 were obtained in this manner.

(Evaluation of Antireflective Articles)

The characteristics of each antireflective article were evaluated by the following methods. The results are shown in Table 2 and Table 3.

(Integral Reflectivity)

While the rear surface of the antireflective article (the reinforced glass substrate side) was treated with a black ink to eliminate rear surface reflection, the integral reflectivity was measured at an incidence angle of 5° in a wavelength region of 380 nm to 780 nm using a spectrophotometer V-550 (manufactured by JASCO Corporation) equipped with an adaptor ARV-474, and the average reflectivity was calculated, thereby evaluating the antireflection.

(Pencil Hardness Test)

A pencil hardness evaluation described in JIS K5400 was performed, and then, the pencil marks were removed by an eraser. After each sample was subjected to moisture-conditioning at a temperature of 25° C. and a humidity of 60% RH for 3 hours, the sample was evaluated in accordance with the following criteria by using a test pencil prescribed in JIS S6006. For a sample having a mark seen after the test, the test mark was observed by SEM whether the particles were separated and whether the particles were crashed.

A: no mark is seen after the test

B: a weak mark is seen after the test, but there is no problem

C: a remarkable mark is seen after the test

(B/A)

The antireflective article was gashed by, for example, a diamond cutter and cut through the gash to expose its cross-section. After carbon deposition was performed on the cross-section, etching processing was performed for 10 minutes. Using a scanning electron microscope (SEM), 20 visual fields were observed and photographed at 5,000 folds. In the obtained image, a distance A between apexes of adjacent convex portions at an interface formed by the air and the sample, and a distance B between a straight line connecting the adjacent convex portions and a concave portion were measured at 100 points, and calculated as an average value of B/A.

(Transmittance)

The transmittance of 550-nm light was measured by a UV/vis spectrometer (Shimazu U2400). The transmittance is preferably 85% or more, and more preferably 90% or more because there is no cloudiness.

TABLE 2

| Sample | Integral | Pencil hard- | | |
|---|---|---|---|---|
| No. | reflectivity | ness 4H | Transmittance | |
| A1 | 1.3% | A | 92% | Ex. |
| A2 | 1.3% | A | 92% | Ex. |
| A3 | 3.8% | C (film is | 80% | Comp. |
| | | peeled) | | Ex. |
| A4 | 2.0% | C (particles are | 90% | Comp. |
| | | separated) | | Ex. |
| A5 | 1.3% | A | 92% | Ex. |
| A6 | 1.3% | A | 92% | Ex. |
| A7 | 1.3% | A | 92% | Ex. |
| A8 | 1.3% | C (particles are | 92% | Comp. |
| | | crushed) | | Ex. |
| A9 | 1.3% | C (particles are | 92% | Comp. |
| | | crushed) | | Ex. |
| A10 | 1.3% | A | 92% | Ex. |
| A11 | 1.4% | A | 92% | Ex. |
| A12 | 1.2% | A | 92% | Ex. |
| A13 | 1.0% | A | 94% | Ex. |
| A14 | 1.5% | A | 91% | Ex. |
| A15 | 4.0% | A | 93% | Comp. |
| | | | | Ex. |
| A16 | 1.4% | A | 92% | Ex. |
| A17 | 1.7% | A | 92% | Ex. |
| A18 | 1.3% | A | 92% | Ex. |

TABLE 3

| Sample. | | |
|---|---|---|
| No. | Pencil Hardness 5H | Pencil Hardness 6H |
| A1 | C (particles are crushed) | C (particles are crushed) |
| A5 | A | C (particles are crushed) |
| A6 | A | A |
| A7 | A | C (particles are crushed) |
| A10 | A | A |
| A11 | A | A |
| A12 | A | A |
| A13 | A | A |
| A14 | A | A |
| A16 | B (some of particles are slightly | C (particles are crushed) |
| | separated) | |
| A17 | B (some of particles are slightly | C (particles are crushed) |
| | separated) | |
| A18 | A | A |

The foregoing description of the exemplary embodiments of the present invention has been provided for the purpose of illustration and description. It is not intended to be exhaustive or to limit the invention to the precise forms disclosed. Obviously, many modifications and variations will be apparent to a person skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. An antireflective article comprising:
a chemically reinforced glass substrate with a surface compressive stress of 30 kg/mm² or more; and
an antireflection layer containing a binder resin, metal oxide particles, and a metal chelate catalyst, above the chemically reinforced glass substrate,
wherein the antireflection layer has a moth-eye structure in an unevenness shape constituted by the metal oxide particles on a surface at a side opposite to a side at which the chemically reinforced glass substrate is provided,
the unevenness shape of the antireflection layer has a ratio B/A of 0.5 or more, which is a ratio of a distance B between a center of apexes of adjacent convex portions and a concave portion to a distance A between the apexes of the adjacent convex portions,
an average primary particle diameter of the metal oxide particles is 150 nm to 380 nm,
a surface hydroxyl group content of the metal oxide particles is 1.00×10⁻¹ or less,
an indentation hardness of the metal oxide particles is 400 MPa or more, and
the binder resin is a resin formed by a hydrolysis and a condensation reaction of a compound represented by Formula (1):
Rₙ—Si—X₄₋ₙ Formula (1)
wherein R represents an alkyl group having 1 to 10 carbon atoms, which may be substituted with other elements than a carbon atom,
X represents a hydrolysable group,
n represents 0 to 2,
R's may be same or different, and X's may be same or different.

2. The antireflective article according to claim 1,
wherein the metal oxide particles are silica particles.

3. The antireflective article according to claim 1,
wherein the metal oxide particles are calcined silica particles.

4. The antireflective articles according to claim 1,
wherein R in Formula (1) is a methyl group or an ethyl group.

5. The antireflective articles according to claim 1,
wherein n in Formula (1) represents 4.

6. The antireflective article according to claim 1,
wherein the metal chelate catalyst is a metal complex constituted by a metal element selected from Group 2, Group 4, Group 5, and Group 13 of a periodic table, and an oxo or hydroxyl oxygen-containing compound selected from β-dikentone, ketoester, hydroxycarboxylic acid or ester thereof, aminoalcohol, and an enolic active hydrogen compound.

7. The antireflective article according to claim 1,
wherein a hardcoat layer is provided between the chemically reinforced glass substrate and the antireflection layer.

8. A cover glass comprising the antireflective article according to claim 1.

9. An image display device comprising the antireflective article according to claim 1.

10. An image display device comprising the cover glass according to claim 8.

11. A method of manufacturing an antireflection article including a chemically reinforced glass substrate with a surface compressive stress of 30 kg/mm² or more and an antireflection layer containing a binder resin, metal oxide particles, and a metal chelate catalyst above the chemically reinforced glass substrate, the method comprising:
applying, above the chemically reinforced glass substrate, a composition containing:
the metal oxide particles having an average primary particle diameter of 150 nm to 380 nm, a surface hydroxyl group content of 1.00×10⁻¹ or less, and an indentation hardness of 400 MPa or more;
the metal chelate catalyst; and
a compound represented by Formula (1):
Rₙ—Si—X₄₋ₙ Formula (1)
wherein R represents an alkyl group having 1 to 10 carbon atoms, which may be substituted with other elements than a carbon atom,
X represents a hydrolysable group,
n represents 0 to 2, and
R's may be same or different, and X's may be same or different; and
subjecting the compound represented by Formula (1) to a hydrolysis and a condensation reaction to form the binder,
wherein the antireflection layer has a moth-eye structure in an unevenness shape constituted by the metal oxide particles on a surface at a side opposite to a side at which the chemically reinforced glass substrate is provided, and
the unevenness shape of the antireflection layer has a ratio B/A of 0.5 or more, which is a ratio of a distance B between a center of apexes of adjacent convex portions and a concave portion to a distance A between the apexes of the adjacent convex portions.
